(19) United States
(12) Patent Application Publication
(10) Pub. No.: US 2015/0038627 A1
(43) Pub. Date: Feb. 5, 2015

(54) Renewable Raw Material Based Coating Compositions

(71) Applicant: Propan Raya, Tangerang (ID)

(72) Inventors: Mircea-Mihai Manea, Malmo (SE); Supriratno, Tangerang (ID); Sri Pauliana, Tangerang (ID)

(73) Assignee: Propan Raya, Tangerang (ID)

(21) Appl. No.: 13/955,730

(22) Filed: Jul. 31, 2013

(51) Int. Cl. C09D 167/08

(52) U.S. Cl. CPC C09D 167/08
USPC 524/391; 524/604; 524/539

(57) ABSTRACT

This disclosure relates to coating compositions that include a film-forming material and solvent. The coating compositions may contain from about 65% to 100%, by weight, renewable materials. The renewable material may be derived from renewable feedstock materials, including renewable biomass feedstock materials.

### FIELD OF THE INVENTION

This disclosure relates to coating compositions including one or more renewable materials.

### BACKGROUND

Renewable biomass feed stock is used in a number of industries to support, at least in part, long term sustainable technological growth. These industries include pulp, paper, and wood products enterprises, and others in which renewable feedstock is effectively and/or profitably used.

The pressure to reduce the greenhouse effect, more stringent regulations of waste disposal, and increasing awareness of sustainable development has given rise to a steadily developing bioproduct market. In some cases the general level of awareness and positive attitude towards sustainable development is an intrinsic part of many corporations' business plans, and sometimes surpasses the desire to consider the recyclability or materials.

Despite the common perception that renewable feedstock is generally more expensive than some other materials, environmental concerns and pertinent legislation are causing more and more corporations to develop and produce greener products in a bid to reduce the carbon dioxide emissions of the industrial sector.

Coatings are ubiquitous materials with a variety of uses. Coatings should exhibit certain properties, including but not limited to storage stability, fast curing times, good chemical and physical properties, and in general they should be workable and low energy consuming.

In the past, coatings based on raw materials from renewable feedstock suffered drawbacks not present in coatings based on other materials. For example, some coatings based on raw materials from renewable feedstock exhibited slow drying and/or had no more than average chemical and/or physical properties. In some instances, even when polymer or film forming materials in the coating composition are derived, to a large extent, from a renewable biomass feedstock, the solvents employed typically were derivatives from fossil material oil or coal. Some water-based coating systems have been prepared, but using water as a solvent requires an energy-intense drying process that increases the overall carbon footprint.

There is a general need for products that are made in a way that takes into consideration the main factors that define sustainability, such as economics in terms of profit and the environment in terms of impact on the planet. In other words, products with a “low carbon footprint” are desirable, including coatings that may reduce the emission of solvent per square meter, do not pose any swelling problems on cellulosic substrates or any other porous substrates, and/or are more environmentally friendly and require less energy in the drying process.

### BRIEF SUMMARY

Coating compositions are provided, which comprise a film-forming material and solvent, wherein from about 65% to 100% by weight of the coating compositions comprise renewable material. The renewable material may be derived from renewable feedstock materials, including renewable biomass feedstock materials.

### DETAILED DESCRIPTION

Coating compositions are provided that include at least one renewable material. The coating compositions generally comprise at least one film-forming material and at least one solvent. In one embodiment, the at least one film-forming material includes at least one renewable material. In another embodiment, the at least one solvent includes at least one renewable material. In a further embodiment, the at least one renewable material and the at least one solvent include at least one renewable material.

As used herein, the term “renewable material” refers to any substance that is not obtained or derived from a fossil source. In certain embodiments, the renewable materials include those obtained or derived from renewable feed stock. In one embodiment, the renewable feed stock is a renewable biomass feed stock. A number of starting materials may be obtained from renewable feed stock, including low-molecular weight alcohols, such as methanol, isopropanol, and butanol. These alcohols may be oxidized, as known in the art, to generate aldehydes, which can be converted into further useful starting materials, including acids. The alcohols also may be dehydrated, as known in the art, which can allow for the generation of unsaturated building blocks. These unsaturated building blocks may be trimerized, as known in the art, which can lead to the production of diacids, such as phthalic anhydride and others. Film forming material

In embodiments, the film-forming material includes at least one polymer. The polymer may be a binder or resin. The film-forming material may be produced, at least in part, from one or more renewable materials.

In embodiments, the film-forming material includes nitrocellulose. The nitrocellulose may contain from about 10.7 to about 12.3% nitrogen, or about 11% nitrogen by weight. In certain embodiments, the nitrocellulose is alcohol soluble. In other embodiments, the nitrocellulose is ester soluble.

In embodiments, the film-forming material includes an alkyd. Generally, the alkyds used as film-forming materials may be made by any processes known in the art. In one embodiment, the alkyd is derived from natural oil and one or more polyols. The natural oil, in some embodiments, may be vegetable oil. The one or more polyols, in certain embodiments, are synthesized by Cannizzaro reaction of aldehydes, such as acetaldehyde, propionaldehyde, butyraldehyde, isobutyraldehyde, heptanal, or a combination thereof. These aldehydes and others may be obtained by oxidation of corresponding mono-alcohols obtained by fermentation of renewable materials.

In one embodiment, the alkyd may be produced from vegetable oils, vegetable oil fatty acids, polyols, polyacids, or a combination thereof.

In one embodiment, the alkyd is ethanol soluble. In another embodiment, the coating composition contains an alkyd that is ethanol soluble and the coating composition has a renewable carbon ratio of from about 89% to about 95%.

In one embodiment, the alkyd contains from about 30% to about 60% by weight vegetable oils, polyols, and dibasic acids. The vegetable oils, in certain embodiments, may include palm oil, coconut oil, tall oil fatty acids, soybean oil, castor oil, used cooking oil, or a combination thereof. The polyols, in certain embodiments, may include glycerol, polyglycerol, pentaerythritol, trimethylol propane, neopentyl glycol, dimethylol propionic acid, dimethylol butanoic acid, trimethylol ethane, 2-butyl-2-ethyl-1,3-propane diol, propane diol, 2-methyl propane diol, hydroxypivalic acid neopentylglycolester, or a combination thereof. The dibasic acids, in certain embodiments, may include phthalic anhydride, adipic acid, or a combination thereof.

In some embodiments, the alkyd is made through trans-esterification of a natural oil in the presence of a polyol to generate hydroxyl functional groups that are reacted to produce the alkyd polymer. When vegetable oil fatty acids are employed, the trans-esterification step may not be necessary and the process may be performed in a single step or in a one-pot process.

In some embodiments, the esterification reaction must be stopped at an acid number of 20 to 35 mgKOH/g on solid polymer, in order to secure good compatibility of the alkyd with polar solvents such as methanol, ethanol, propanol, and butanol. In certain embodiments, a low acid number may jeopardize the solubility of the alkyd in alcohols. In other embodiments, a high acid number may jeopardize the chemical and physical properties of the coatings due to the product's low molecular weight.

In one embodiment, the alkyd is obtained by esterification of dibasic acids from fossil sources, such as phthalic anhydride, isophthalic acid, terephthalic acid, or a combination thereof. Also, adipic acid may be used, which can be obtained from the C7-cut of sunflower oil. The esterification may be performed in a solution of ethanol, isopropanol, or acetic acid esters at a non-volatile content higher than about 70%.

In one embodiment, the polyols employed in the formation of the alkyds described herein are obtained by forming heptanal in the C7 cut of the fatty acids of vegetable oils, and subjecting the heptanal to a Cannizzaro reaction with formaldehyde to form 2-(hydroxymethyl)-2-pentylpropane-1,3-diol. In another embodiment, the polyols employed in the formation of the alkyds described herein are obtained by converting methanol and ethanol to aldehydes that are then converted to tetrols and hexols, such as pentaerythritol and di-pentaerythritol. In some embodiments, the adipic acid used as a diacid in the production of the alkyds may be derived from the C7 cut of vegetable fatty acids.

In embodiments, the film-forming material includes one or more resins, such as natural resins (such as rosin), rosin esters, shellac, amino resins, or a combination thereof. Examples of amino resins include those based on urea, melamine, glycoluril, and formaldehyde. The amino resins may be used in embodiments in which cross-linking is required. In one embodiment, the amino resins are derived from synthetic raw materials obtained from fossil sources. In another embodiment, the amino resins are derived from renewable materials. For example, formaldehyde may be produced by oxidizing methanol obtained from the fermentation of potato crops. In a further embodiment, the amino resins are derived in part from synthetic raw materials obtained from fossil sources and in part from renewable materials.

### Solvents

Generally, the solvent may be any fluid that is compatible with the film-forming material. In one embodiment, the solvent is derived from synthetic raw materials obtained from fossil sources. In another embodiment, the solvent is derived from renewable materials. For example, the solvent may include enzymatic products from feed stock, such as methanol, ethanol, propanol, isopropanol, flycol, flycol ethers (with methylic or ethylic alcohol), butanol, glycerol cyclic formal, flycol cyclic carbonates, esters of acetic acid (as fermentation product with said alcohols), acid lactic esters (such as ethyl lactate or butyl lactate), or a combination thereof. In a further embodiment, the solvent is derived in part from synthetic raw materials obtained from fossil sources and in part from renewable materials.

### Coating Compositions

The coating compositions include at least one film-forming material and at least one solvent. The at least one film-forming material, the at least one solvent, or both include, at least in part, one or more renewable materials. The coating compositions can be prepared by combining one or more film-forming materials and one or more solvents in any acceptable manner. In some embodiments, the coating compositions include materials not obtained or derived from renewable materials. In certain embodiments, the materials not obtained or derived from renewable materials are derivatives of silica, urea, triazine, formaldehyde, or a combination thereof.

In one embodiment, renewable material is present in the coating composition in an amount of from about 65% to 100% by weight of the coating composition. In another embodiment, renewable material is present in the coating composition in an amount of from about 70% to 100% by weight of the coating composition. In a further embodiment, renewable material is present in the coating composition in an amount of from about 75% to 100% by weight of the coating composition. In a still further embodiment, renewable material is present in the coating composition in an amount of from about 80% to 100% by weight of the coating composition. In yet another embodiment, renewable material is present in the coating composition in an amount of from about 85% to 100% by weight of the coating composition. In some embodiments, renewable material is present in the coating composition in an amount of from about 90% to 100% by weight of the coating composition. In certain embodiments, renewable material is present in the coating composition in an amount of from about 95% to 100% by weight of the coating composition.

In one embodiment, the coating composition is clear, colorless, or both. In another embodiment, the coating composition includes one or more pigments or dyestuffs. Any pigments or dyestuffs known in the art may be used, so long as they are compatible with the components of the coating composition. The pigments may be obtained or derived from synthetic raw materials derived from fossil sources, renewable materials, or a combination of both. In embodiments, the coating compositions containing one or more renewable materials are clear, and the coating compositions comprise at least 82% by weight of renewable material.

Generally, the coating composition can be applied to any material, including natural or synthetic materials. For example, the coating compositions may be applied to wood, metal, stone, concrete, sheet rock, or a composite material.

The coating compositions containing one or more renewable materials may be capable of physically drying or chemically drying. As used herein, the terms “dry” or “drying” refer to the evaporation of solvent or moisture, curing (e.g., cross-linking), or both. In one embodiment, the chemical drying process is an acid curing process. A coating composition may be cured via an acid catalyst. In some embodiments, acid curing coating compositions containing one or more renewable materials are produced by combining aminoformaldehyde with at least one alkyd. In certain embodiments, the physical drying or acid curing coating compositions contain urea, melamine, or glycoluril formaldehyde resins. In other embodiments, physical drying coating compositions containing one or more renewable materials are produced by combining nitrocellulose, rosin esters, or both to at least one alkyd. The rosin esters may be obtained or derived from glycerol, pentaerythritol, trimethylol propane, or a combination thereof.

In one embodiment, the coating composition is curable via an acid catalyst, and has a renewable carbon ratio of from about 82% to about 95%. In another embodiment, the coating composition is physically dried and has a renewable carbon ratio of from about 81% to about 95%.

Generally, the amount of energy required to dry the coating compositions containing one or more renewable materials can be increased or decreased based on the components in the coating compositions. For example, the amount of drying energy may be lowered by using low boiling point alcohols and/or esters formed from vegetable oil fatty acids and glycols. The low boiling point alcohols and esters formed from vegetable oil fatty acids and glycols may be obtained or derived from renewable materials. Examples of low boiling point alcohols include, but are not limited to, ethanol, propanol, isopropanol, butanol, or a combination thereof. Examples of glycols include, but are not limited to, ethylene glycol, propylene glycol, or a combination thereof. Examples of esters are acetic acid ester with methanol, ethanol, propanol, isopropanol, butanol, isobutanol, ethylene glycol, propylene glycol, or a combination thereof. Other esters are derived from vegetable fatty acids or acids from C7 cut of vegetable fatty acids with methanol, ethanol, propanol, isopropanol, butanol, isobutanol, ethylene glycol, propylene glycol, or a combination thereof.

In one embodiment, the coating compositions containing one or more renewable materials have physical and/or chemical characteristics that are at least similar to those produced from fossil sources. In other embodiments, the coating compositions containing one or more renewable materials have physical and/or chemical characteristics that equal those produced from fossil sources. In certain embodiments, the coating compositions containing one or more renewable materials have physical and/or chemical characteristics that exceed those produced from fossil sources. For example, the coating compositions containing one or more renewable materials may include a heavier solvent used for the purpose of leveling or as media for the additives to enhance their activity, the heavier solvent being derived from vegetable fatty acids linseed oil fatty acid, soybean oil fatty acid, or sunflower oil fatty acid that has been esterified with other alcohols, such as methanol, ethanol, ethylene glycol, propylene glycol, or butanol. The double bond of the fatty acid of the heavier solvent may undergo auto-oxidation so that they are not VOCs and polymerize in the film, thereby enhancing the hydrophobic properties of the coatings. As a further example, other esters—such as those derived from gluconic acid and butanol—may act to prevent surface defects (such as craters, scars, bubbles, pinholes, orange peel, or boiling marks) and/or improve leveling.

In one embodiment, the coating compositions containing one or more renewable materials are substantially fragrance free. As used herein, the term “fragrance free” refers to coating compositions that have no substantial odor prior to application, after application, after drying, or any combination thereof. In some embodiments, the coating compositions can be made substantially fragrance free by using alcohols obtained or derived from renewable materials, including those obtained or derived from biomass feed stock. In another embodiment, the coating compositions may include a fragrant additive. Generally, any fragrant additive may be used that is compatible with the other components of the coating compositions. In particular embodiments, the fragrant additive is present in the coating composition in an amount from about 0.05% to about 0.2% by weight of the coating composition. In a particular embodiment, the fragrant additive is isoamyl acetate.

In one embodiment, the coating composition exhibits a haptic effect, i.e., soft feeling. The haptic effect may be achieved, in some embodiments, by combining shellac and nitrocellulose. Generally, shellac functions as a tough natural primer, sanding sealant, tannin-blocker, odor-blocker, or stain, and a high-gloss varnish can be used to enhance these surface properties. To achieve the above-described haptic effect, in some embodiments, the coating composition has a wax content of from about 3 to about 5%, by weight. This amount of wax, in certain embodiments, can provide surface smoothness without haze or matting effect, while enhancing the gloss and lowering the friction coefficient of the surface. In embodiments, the coating compositions containing one or more renewable materials contain from about 0.3 to about 5%, by weight, of unbleached shellac.

The present invention further exhibits the beneficial contribution of using a higher ratio of renewable carbon, calculated with the formula:

$$( \% ) = \frac{Total \text{-} Weitht \text{-} of \text{-} renewable \text{-} Carbon \text{-} of \text{-} Polymer}{Total \text{-} Weight \text{-} of \text{-} Carbon \text{-} of \text{-} Polymer} \times 100$$

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

In the following examples, the nitrocellulose (NC) components and “Solvent Mix” contain the following materials (the percentages are by weight):

| | NC ½ | | | |
|---|---|---|---|---|
| | alcohol base | NC ¼ | NC 20 | Solvent Mix |
| NC ½ second | 30.00% | | | |
| Solvent Mix | 30.00% | | | |
| Ethanol | 40.00% | | | |
| NC ¼ second | | 50.00% | | |
| Ethyl acetate | | 50.00% | | |
| NC 20 second | | | 20.00% | |
| methyl isobutyl ketone | | | 30.00% | |
| (MIBK) | | | | |
| Isopropanol (IPA) | | | 5.00% | |
| Toluene | | | 35.00% | |
| Methoxy propyl acetate | | | 10.00% | 40% |
| Butyl acetate | | | 40% | |
| Methoxy propanol | | | 20% | |
| Renewable carbon ratio | 46% | 49% | 70% | 72% |

In this table, viscosity ranges of nitrocellulose are expressed in standard terms, i.e., seconds, quarter second, half second, etc. The viscosity is the time it takes for an air bubble of 0.5-2.0 cm³ to cover the distance of 500 mm between two marks in a 7 mm diameter Cochius tube at 18° C.

### EXAMPLE 1

### Preparation of Alkyd Resin

A reference alkyd resin was prepared having the components listed in the following table:

| Component | Parts by weight |
|---|---|
| Coconut Oil | 20.25 |
| Pentaerythritol | 14.538 |
| Monoethylene glycol | 1.024 |
| Benzoic acid | 4.050 |
| Phthalic anhydride | 21.350 |
| Maleic anhydride | 0.05 |
| Xylene | 39 |
| Renewable | 78.96 |
| Carbon ratio, % | |

The reference alkyd had a total content of renewable materials from renewable biomass feed stock of 35.8% by weight when pentaerythritol and monoethylene glycol were produced from the renewable biomass feed stock. In other samples, the alkyd resin was made using ethyl or butyl acetate derived from the renewable biomass feed stock as the dilution solvent. In these samples, the alkyd resin had a total content of renewable materials from renewable biomass feed stock of about 75% by weight.

### EXAMPLE 2

### Preparation of Alkyd Resin

Another reference alkyd was prepared having the components listed in the following table:

| Component | Parts by weight |
|---|---|
| Coconut oil | 27.58 |
| Pentaerythritol | 13.33 |
| Trimethylol propane | 1.014 |
| Phthalic anhydride | 18.212 |
| Maleic anhydride | 0.652 |
| Xylene | 39.958 |
| Renewable | 72.24 |
| Carbon ratio, % | |

The reference alkyd in this example had a content of renewable biomass feed stock materials of about 41% by weight.

### EXAMPLE 3

### Preparation of Alkyd Resins

Seven additional alkyd resins (Samples 1-7, labeled S. 1-S. 7) were prepared that contained the components shown in the following table. The table also includes various properties of the seven samples, including oil length, Gardner viscosity, non-volatile content, ethanol tolerance, acid value, and the percentage of renewable materials.

| | S. 1 | S. 2 | S. 3 | S. 4 | S. 5 | S. 6 | S. 7 |
|---|---|---|---|---|---|---|---|
| Raw Materials | | | | | | | |
| Coconut Oil (g) | 469.54 | 469.58 | 486.87 | | 458.28 | 462 | 481.87 |
| Short chain fatty acids | | | | 417.7 | | | |
| (C₈-C₁₂) (g) | | | | | | | |
| Tall oil fatty acids (g) | 41.10 | | | | | | |
| Soybean oil fatty | | 40.37 | | | | | |
| acids (g) | | | | | | | |
| Phthalic anhydride (g) | 291.98 | 292 | 255.33 | 293.14 | 313.34 | 315.88 | |
| Maleic anhydride (g) | 6.62 | 6.62 | 2 | 7.52 | 8.04 | | 8.46 |
| Adipic acid (g) | | | 61.18 | | | | 278 |
| Rosin (g) | | 0.71 | | | | | |
| Pentaerythritol (g) | 190.76 | 190.71 | 196.62 | 281.64 | 220.33 | 222.12 | 231.67 |
| Properties | | | | | | | |
| Oil length (calculated) | 55 | 55 | 53 | 46 | 50 | 50 | 52 |
| Gardner viscosity | O-P | R− | U− | Z3+ | V+ | U+ | U+ |
| (ASTM D1545) | | | | | | | |
| Non-volatile content, %, | 74.74 | 74.75 | 74.89 | 75.35 | 75.13 | 75.40 | 75.13 |
| in a mix of | | | | | | | |
| isopropanol/ethanol, | | | | | | | |
| ½ by weight (ASTM | | | | | | | |
| D1644) | | | | | | | |
| Ethanol tolerance, | 35 | 44 | 49 | 40 | 28 | 23 | 16 |
| pbw, ethanol to 100 g | | | | | | | |
| resin solution (ASTM | | | | | | | |
| D1198) | | | | | | | |
| Acid value, | 29 | 18.6 | 24.3 | 23.8 | 24.3 | 23.2 | 19 |
| mgKOH/g, on | | | | | | | |
| delivery form (ASTM | | | | | | | |
| D1639) | | | | | | | |
| Renewable material, % | 70.24 | 70.138 | 68.1 | 69.9 | 67.9 | 68.5 | 93.7 |
| on solid | | | | | | | |
| (calculated) | | | | | | | |
| Renewable material, % | 77.68 | 77.60 | 76.075 | 77.425 | 75.925 | 76.375 | 95.3 |
| on solution | | | | | | | |
| (calculated) | | | | | | | |
| Renewable Carbon | 88.99 | 88.99 | 90.50 | 90.52 | 88.94 | 88.79 | 92.65 |
| ratio, % | | | | | | | |

### EXAMPLE 4

### Preparation of Acid-Curing Coating Compositions

Alkyd samples 1-7 of Example 3 were used to form coating compositions. The coating compositions of this example were chemical drying coating compostions. A coating composition made using alkyd sample 5 of Example 3 was compared to a reference coating. The components and characteristics of the reference coating composition and the coating composition made using alkyd sample 5 of Example 3 are shown in the following table. The reference coating composition is a standard coating, made with non-renewable materials, and the coating composition made using alkyd sample 5 of Example 3 is an acid curing coating composition made, in part, with renewable materials.

| | | | Coating From |
|---|---|---|---|
| | | Coating From | Renewable Biomass |
| | | Renewable | Feed Stock, low |
| | Reference | Biomass Feed | formaldehyde |
| Raw Materials | Coating | Stock | emission |
| Alkyd as in S. 5 | — | 39.2 | 30 |
| Reference alkyd 1, 60% | 49 | — | |
| in xylene | | | |
| Melamine formaldehye | 42.7 | 42.7 | |
| resin 60% in butanol | | | |
| Butylated glycoluril | | | 6.42 |
| formaldehyde resin, | | | |
| 100% | | | |
| NC ¼ | | | 22.4 |
| N Butanol | 5.2 | — | |
| Silicone defoamer | 0.21 | 0.21 | 0.21 |
| Triethyl amine | 0.15 | 0.15 | |
| Xylene | 1.08 | — | |
| Pegasol 100 (The | 1.02 | — | |
| Dovechem Group, | | | |
| Singapore) | | | |
| White sprite | 0.64 | — | |
| Ethanol | — | 3.6 | 14.2 |
| Ethyl acetate | — | 3.6 | |
| Butyl acetate | — | | 9.4 |
| Propylene glycol | — | 3.6 | |
| Propyleneglycol | — | 3.6 | 14.03 |
| monomethyl ether | | | |
| Methoxy propyl acetate | — | 3.34 | 3.34 |
| Total | 100 | 100 | 100 |
| Renewable biomass feed | 17.54 | 44.06 | 92.8 |
| stock content, % | | | |
| Renewable Carbon ratio | 57 | 72 | 71.05 |
| on solid, % | | | |
| Renewable Carbon ratio | 45.1 | 70 | 70.47 |
| on liquid, % | | | |
| Viscosity, DIN Cup 4 | 70 | 50 | 70 |
| (DIN 53211) | | | |
| Non-volatile content % | 55 | 55 | 40 |
| (ASTM D1644) | | | |
| Test Item | | | |
| Hardness (osc) (ASTM | 200 micron wet film | | |
| D4366-02 (06-01)) | | | |
| After 1 hour | 11 | 11 | 20 |
| After 3 hours | 23 | 21 | 35 |
| After 5 hours | 32 | 27 | 72 |
| After 24 hours | 83 | 33 | 112 |
| After 6 days | 69 | 55 | 120 |
| After 7 days | 70 | 56 | 118 |
| Drying time (min) | 14 | 14 | 12 |
| Film appearance | 5 | 5 | 5 |

Chemical Resistance (ASTM 1308-02 (0601))

| | | | |
|---|---|---|---|
| Xylene (60 seconds) | 5 | 5 | 5 |
| Acetone (60 seconds) | 5 | 5 | 5 |
| Methanol (60 seconds) | 5 | 5 | 5 |
| Butyl acetate | 5 | 5 | 5 |
| (60 seconds) | | | |
| NaOH 10% (24 hours) | 3 | 3 | 4 |
| Water (24 hours) | 5 | 5 | 5 |
| HCl 20% (24 hours) | 3 | 3 | 4 |

(5-no marks, 4-marks slightly visible from only certain angle, 3-mark visible from all angles, 2-marks strongly visible, 1-film attacked and destroyed)

For the drying time calculation, both coatings were cured using an ethanol solution of para-toluensulfonic acid at a ratio of 6.5% by weight, calculated on melamine resin solid content.

The coating compositions containing one or more renewable materials unexpectedly exhibited a very good tolerance to methanol and no spot was visible from any observation angle. Also, the coating compositions containing one or more renewable materials exhibited unexpected equal chemical resistance to NaOH (10% solution) and HCl (20% solution) compared to the standard formulation based on fossil raw materials. Surprisingly, the chemical and mechanical performance was found to be equal to standard alkyd in spite of the higher acid number of the alkyd and the high compatibility with ethanol.

### EXAMPLE 5

### Preparation of Physical Drying Coating Compositions

A series of physically drying coating compositions made, in part, from renewable materials were prepared and compared to several reference coating compositions. The components and characteristics of the various coatings are shown in the following table. The coating compositions in this example were nitrocellulose-based clear coating compositions.

In the table, coating compositions Ia, IIa, IIIa, Ic, IIc, and IIIc contained reference alkyd 1 from Example 1; coating compositions IVa and IVc contained reference alkyd 1 from Example 1 and reference alkyd 2 from Example 2; coating compositions Ib, IIb, IIIb, IVb, Vb, VIb, Id, IId, IIId, IVd, Vd, and VId contained the S. 5 alkyd from Example 3.

| Raw Materials | Ia | IIa | IIIa | Iva | Ib | IIb | IIIb | IVb | Vb | VIb |
|---|---|---|---|---|---|---|---|---|---|---|
| Reference alkyd 1 | 28 | 31.6 | 32.6 | 16.9 | | | | | | |
| Alkyd of S. 5 | | | | | 10.9 | 10.8 | 10.7 | 10.6 | 10.36 | 10.1 |
| Reference Alkyd 2 | | | | 11.3 | | | | | | |
| Butylcellosolve | | | | | 3 | 3 | 3 | 3 | 3 | 3 |
| Zinc Stearate | 1.6 | 1.6 | 2 | 1.6 | 1 | 1 | 1 | 1 | 1 | 1 |
| Talcum | 3 | | | | | | | | | |
| Xylene | 2 | 3 | 4.6 | 2 | | | | | | |
| NC ½ alcohol base | | | | 13.1 | 43.1 | 42.9 | 42.5 | 42.1 | 41.1 | 40.2 |
| NC ¼ | 24.8 | 28.2 | 32.9 | 16.3 | | | | | | |
| NC 20 | 7.1 | 7.1 | 5 | | | | | | | |
| Shellac (10% | | | | | | 0.92 | 2.73 | 4.5 | 8.81 | 12.9 |
| solid) | | | | | | | | | | |
| Solvent mix | 5 | 4 | 5 | | 16 | | 15 | 14.4 | 12.9 | 11.45 |
| Purasolv EL, (ethyl | | | | | | 15.69 | | | | |
| lactate) | | | | | | | | | | |
| Butyl Acetate | | | 7 | | 8 | 8 | 8 | 8 | 8 | 8 |
| Methylacetate | | | | 4 | | | | | | |
| Ethyl acetate | | | | 3 | | 1.6 | | | | |
| BYK 065 | | | | | 0.2 | 0.2 | 0.2 | 0.2 | 0.2 | 0.2 |
| BYK 141 | 0.1 | 0.1 | | | | | | | | |
| Loxanol EFC 20 | 0.48 | 0.54 | 1.22 | | 1.8 | | 1.78 | 1.76 | 1.72 | 1.69 |
| Purasolv EHL | | | | | | 0.2 | | | | |
| (ethyl-hexyl | | | | | | | | | | |
| lactate) | | | | | | | | | | |
| Perenol E1 | | | 0.1 | | | | | | | |
| BYK 052 | | | | 0.3 | | | | | | |
| Xylene | | | 4.58 | | | | | | | |
| Ethanol | | | | 2 | 16 | 15.69 | 15.09 | 14.44 | 12.91 | 11.46 |
| Toluene | 19.92 | 14.86 | | 14.5 | | | | | | |
| Naphtalene | 6 | 6 | 5 | 15 | | | | | | |
| Methanol | 2 | 3 | 2 | | | | | | | |
| TOTAL | 100 | 100 | 100 | 100 | 100 | 100 | 100 | 100 | 100 | 100 |
| Renewable biomass | 41.44 | 51.12 | 54.8 | 47.08 | 96.3 | 96.3 | 96.3 | 96.3 | 96.3 | 96.3 |
| feed stock content, % | | | | | | | | | | |
| Renewable Carbon | 59 | 57 | 61 | 59 | 82 | 92 | 89 | 90 | 91 | 91 |
| ratio, % | | | | | | | | | | |
| Non-volatile | 32 | 32 | 36 | 28 | 20 | 20 | 20 | 20 | 20 | 20 |
| content % (ASTM | | | | | | | | | | |
| D1644) | | | | | | | | | | |
| Viscosity DIN | 50 | 50 | 50 | 60 | | | | | | |
| cup 6 (DIN 53211) | | | | | | | | | | |
| Viscosity DIN | | | | | 20 | 20 | 20 | 20 | 20 | 20 |
| cup 4 (DIN 53211) | | | | | | | | | | |

| Raw Materials | Ic | IIc | IIIc | IVc | Id | IId | IIId | IVd | Vd | VId |
|---|---|---|---|---|---|---|---|---|---|---|
| Reference alkyd 1 | 32.8 | 33.4 | 30.8 | 16.7 | | | | | | |
| Alkyd of S. 5 | | | | | 11.4 | 11.37 | 11.26 | 11.16 | 10.9 | 10.66 |
| Reference Alkyd 2 | | | | 13.3 | | | | | | |
| Butylcellosolve | | | | | 3 | 3 | 3 | 3 | 3 | 3 |
| Xylene | 2 | 2 | 4.4 | 2 | | | | | | |
| NC ½ alcohol base | | | | 13.1 | 45.3 | 45.1 | 44.7 | 44.3 | 43.3 | 42.3 |
| NC ¼ | 29.2 | 29.8 | 32.4 | 17.9 | | | | | | |
| NC 20 | 7.1 | 7.1 | 7 | | | | | | | |
| Shellac (10% solid | | | | | | 0.96 | 2.87 | 4.75 | 9.27 | 13.6 |
| in ethanol/ethyl | | | | | | | | | | |
| acetate 70/30) | | | | | | | | | | |
| Purasolv EL (ethyl | | | | | | | | | | 8 |
| lactate) | | | | | | | | | | |
| Solvent mix | 5 | 5 | 5 | | 15.8 | 15.44 | 14.74 | 14.06 | 12.45 | 10.93 |
| Butyl Acetate | | | 5 | | 8 | 8 | 8 | 8 | 8 | 8 |
| Methylacetate | | | | 3 | | | | | | |
| Ethyl acetate | | | | 4 | | | | | | |
| BYK 065 | | | | | 0.2 | 0.2 | 0.2 | 0.2 | 0.2 | 0.2 |
| BYK 141 | 0.1 | 0.1 | | 0.1 | | | | | | |
| Loxanol EFC 20 | 0.56 | 0.57 | 1.23 | | 1.9 | 1.89 | 1.88 | 1.86 | 1.82 | 1.75 |
| Purasolv EHL | | | | | | | | | | 0.28 |
| (ethyl-hexyl lactate) | | | | | | | | | | |
| Silicon KF | 0.2 | 0.3 | 0.2 | | | | | | | |
| BYK 307 | | | | 0.3 | | | | | | |
| Perenol E1 | | | 0.1 | | | | | | | |
| Tego Glide 410 | | | | | 0.6 | 0.6 | 0.6 | 0.6 | 0.6 | 0.6 |
| Xylene | | | 8 | | | | | | | |
| Ethanol | | | | | 13.8 | 13.44 | 12.75 | 12.07 | 10.46 | 8.93 |
| Toluene | 15.04 | 13.73 | 5.87 | 11.6 | | | | | | |
| Naphta | 6 | 6 | | 18 | | | | | | |
| Methanol | 2 | 2 | | | | | | | | |
| TOTAL | 100 | 100 | 100 | 100 | 100 | 100 | 100 | 100 | 100 | 100 |
| Renewable biomass | 52.6 | 53.4 | 57.9 | 49.4 | 96.4 | 96.4 | 96.4 | 96.4 | 96.4 | 96.4 |
| feed stock content, % | | | | | | | | | | |
| Renewable Carbon | 69 | 70 | 69 | 47 | 81 | 83 | 83 | 83 | 94 | 83 |
| ratio, % | | | | | | | | | | |
| Non-volatile content % | 32 | 32 | 32 | 28 | 20 | 20 | 20 | 20 | 20 | 20 |
| (ASTM D1644) | | | | | | | | | | |
| Viscosity DIN | 50 | 50 | 50 | 60 | | | | | | |
| cup 6 (DIN 53211) | | | | | | | | | | |
| Viscosity DIN | | | | | 21 | 21 | 21 | 21 | 21 | 21 |
| cup 4 (DIN 53211) | | | | | | | | | | |
| Chemical resistance | | | | | | | | | | |
| (ASTM D1308- | | | | | | | | | | |
| 02(06-01)) | | | | | | | | | | |
| Cold Water | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Coffee | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Vegetable Oil | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Margarine | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Ketchup | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Ethanol 50% | | | | | | | | | | |
| 1 hour | 4 | 4 | 4 | 4 | 3 | 3 | 3 | 3 | 3 | 3 |
| 16 hours | 4 | 4 | 4 | 4 | 3 | 3 | 3 | 3 | 3 | 3 |
| 24 hours | 4 | 4 | 4 | 4 | 3 | 3 | 3 | 3 | 3 | 3 |
| Acetic Acid 3% | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Beer | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 5 | 5 | 5 | 5 | 5 | 5 |
| Red Wine | | | | | | | | | | |
| 1 hour | 5 | 5 | 5 | 5 | 5 | 5 | 5 | 5 | 5 | 5 |
| 16 hours | 5 | 5 | 5 | 5 | 5 | 5 | 5 | 5 | 5 | 5 |
| 24 hours | 5 | 5 | 5 | 5 | 4 | 4 | 4 | 4 | 4 | 4 |

We claim:

1. A coating composition comprising a film-forming material and a solvent, wherein from about 65% to about 100% by weight of the coating composition comprises renewable material.

2. The coating composition of claim 1, wherein the renewable material is derived from renewable feedstock.

3. The coating composition of claim 2, wherein the renewable feedstock is renewable biomass feedstock.

4. The coating composition of claim 1, wherein the film-forming material comprises a polymer derived from renewable feedstock.

5. The coating composition of claim 4, wherein the film-forming material comprises nitrocellulose and at least one alkyd.

6. The coating composition of claim 1, wherein the solvent comprises one or more renewable materials.

7. The coating composition of claim 6, wherein the solvent comprises methanol, ethanol, propanol, isopropanol, flycol, butanol, a glycerol cyclic formal, an acid lactic ester, or a combination thereof.

8. The coating composition of claim 7, wherein the acid lactic ester is ethyl lactate, butyl lactate, or a combination thereof.

8. The coating composition of claim 1, wherein from about 70% to 100% by weight of the coating composition comprises renewable material.

9. The coating composition of claim 1, wherein from about 75% to 100% by weight of the coating composition comprises renewable material.

10. The coating composition of claim 1, wherein from about 80% to 100% by weight of the coating composition comprises renewable material.

11. The coating composition of claim 1, wherein from about 85% to 100% by weight of the coating composition comprises renewable material.

12. The coating composition of claim 1, wherein from about 90% to 100% by weight of the coating composition comprises renewable material.

13. The coating composition of claim 1, wherein from about 95% to 100% by weight of the coating composition comprises renewable material.

14. The coating composition of claim 1, further comprising a pigment or dyestuff.

15. The coating composition of claim 1, wherein the coating composition is clear and comprises at least 82% by weight of renewable material.

16. The coating composition of claim 1, wherein the coating composition further comprises an acid curing catalyst.

17. The coating composition of claim 16, wherein the coating composition comprises urea, melamime resin, or glycoluril formaldehyde resin, or a combination thereof.

18. The coating composition of claim 1, wherein the coating composition comprises an alkyd that is soluble in ethanol, and wherein the coating composition has a renewable carbon ratio of from about 89% to about 95%.

19. The coating composition of claim 1, wherein the coating composition is curable by an acid catalyst, and wherein the coating composition comprises a renewable carbon ratio of from about 82% to about 95%.

20. The coating composition of claim 1, wherein the coating composition is physically dryable and has a renewable carbon ratio from about 81% to about 95%.

21. A coating composition comprising a film-forming material and a solvent, wherein from about 65% to about 100% by weight of the coating composition comprises renewable material, and wherein the coating composition comprises a renewable carbon ratio of from about 81% to about 95%.
